(19) United States
(12) Patent Application Publication
(10) Pub. No.: US 2009/0134277 A1
(43) Pub. Date: May 28, 2009

(54) LIFESAVING PARACHUTE

(76) Inventors: Yong Sun Kim, Seoul (KR); Dong Seok Kim, Seoul (KR)

Correspondence Address: Workman Nydegger;1000 Eagle Gate Tower, 60 East South Temple, Salt Lake City, UT, 84111, US

(21) Appl. No.: 12/279,488

(22) PCT Filed: Oct. 16, 2007
(86) PCT No.: PCT/KR07/05047

§ 371 Date: Aug. 14, 2008

(30) Foreign Application Priority Data
Jan. 31, 2007 (KR) 10-2007-0009972

(51) Int. Cl. B64D 17/70

(52) U.S. Cl. 244/149

(57) ABSTRACT

The present invention relates to a lifesaving parachute, for moving people in danger to the ground safely in the case of accidents causing the loss of lives, such as fire of a high-storied building, earthquake and the like, which includes a main body having straps for a user to wear the parachute, stick elements formed of a unit length and fixed to the main body along a periphery thereof, elastic elements connected to connection elements of the stick elements for applying elastic force to the stick elements in a spreading direction of the stick elements, and an empty receiving case having an opened lower part for receiving the main body as folded.

### TECHNICAL FIELD

The present invention relates to a lifesaving parachute, and more particularly to, a lifesaving parachute for saving a human life by moving a person in danger to the ground safely in the case of an accident causing the loss of human lives, such as fire of a high-storied building, earthquake and the like.

### BACKGROUND ART

Previously, people on higher stories come down by using a rope or a ladder for escaping shortly from a danger causing the loss of lives in the case of fire or earthquake.

Such escape has, however, problems that it takes much time to come down to the ground by using the rope or the ladder and that even the rope or the ladder is not safe since the fire may be moved on the rope or ladder in the case of fire. Therefore, the loss of human lives remains still unresolved.

Further, if the fire is generated on lower stories, it is almost impossible to use the rope or the ladder because of flames or smoke. Therefore, people are forced to jump to the ground without any lifesaving elements.

### DISCLOSURE OF INVENTION

### Technical Problem

If the building is a low-storied building, the jumped people may be alive but the people may be hugely injured or die if the building is a high-storied building.

In order to resolve the above and any other disadvantages in the lifesaving in the accidental cases has been suggested a parachute, which is formed with a keeping part for keeping the parachute and shoulder straps to be fixed to a human body, wherein the parachute is spread out when a user wearing the parachute jumps from a higher story of the building so that the parachute helps the user to easily and safely land on the ground.

The prior art parachute, which is in the structure that the parachute is spread out as a working lever is pulled out while the user jumps from the higher story, has, still disadvantages that the parachute is not spread out and the user falls down the ground vertically if the user fails to pull out the working lever when the user faints or is in panic.

Further, even though the working lever is normally driven, a time required for the parachute to spread out is almost equal to or longer than a time required for a human body to fall down to the ground vertically by gravity.

Therefore, lifesaving elements using the parachute are not practically utilized in reality.

### Technical Solution

Therefore, the present invention is derived to resolve the above and any other disadvantages of the prior art.

According to the present invention, there is an object to provide a lifesaving parachute which spreads out automatically in a very short time at the instant that a user jumps from a building in an emergency case, thereby saving human lives safely.

According to the present invention, there is another object to provide a lifesaving parachute with improved reliability and safety for a user to use the same without anxiety in an emergency case.

In order to achieve the above objects, according to the present invention, there is provided a lifesaving parachute, which includes a main body having straps for a user to wear the parachute, stick elements formed of a unit length and fixed to the main body along a periphery thereof, elastic elements connected to connection elements of the stick elements for applying elastic force to the stick elements in a spreading direction of the stick elements, and an empty receiving case having an opened lower part for receiving the main body as folded.

Therefore, at the moment that the main body is separated from the receiving case, the stick elements spread the main body very fast by the restoring elastic force of the elastic elements, so that the parachute induces a user to be landed on the ground safely when the user jumps to the ground from a high-storied building in an emergency case.

### BRIEF DESCRIPTION OF THE DRAWINGS

The objects, features and advantages of the present invention will be more clearly understood from the following detailed description in conjunction with the accompanying drawings, in which:

FIG. 1 is a front view showing a lifesaving parachute in use;

FIG. 2 is a plane view showing a spread state of the lifesaving parachute according to a preferred embodiment of the present invention;

FIG. 3 is a plane view showing a routine for folding the lifesaving parachute of the present invention;

FIG. 4 is a partially taken cross-sectional view showing the lifesaving parachute in storage; and

FIG. 5 is a partially taken cross-sectional view showing the lifesaving parachute, which is in use in the case of fire of a building.

### MODE FOR THE INVENTION

Now, a lifesaving parachute according to the present invention will be described in more detail in the structure and operation thereof with reference to the accompanied drawings.

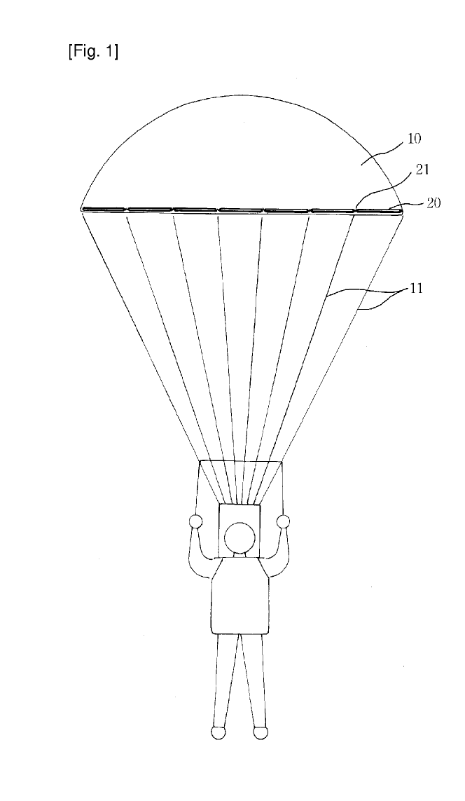

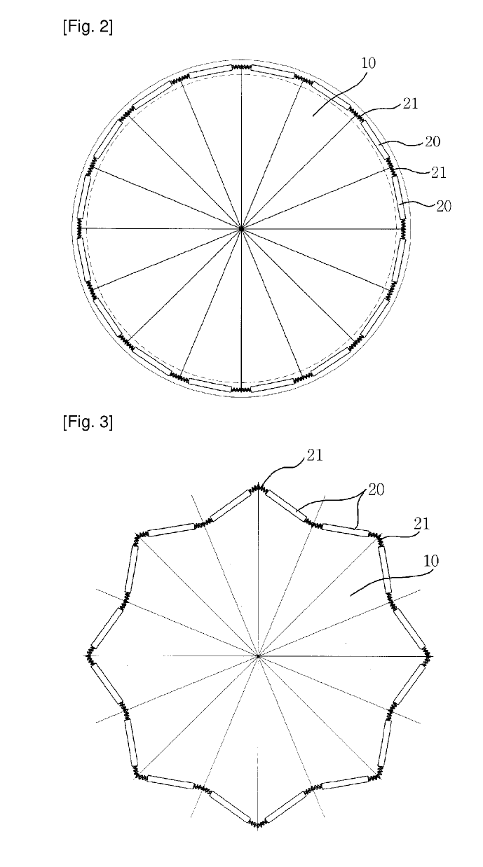

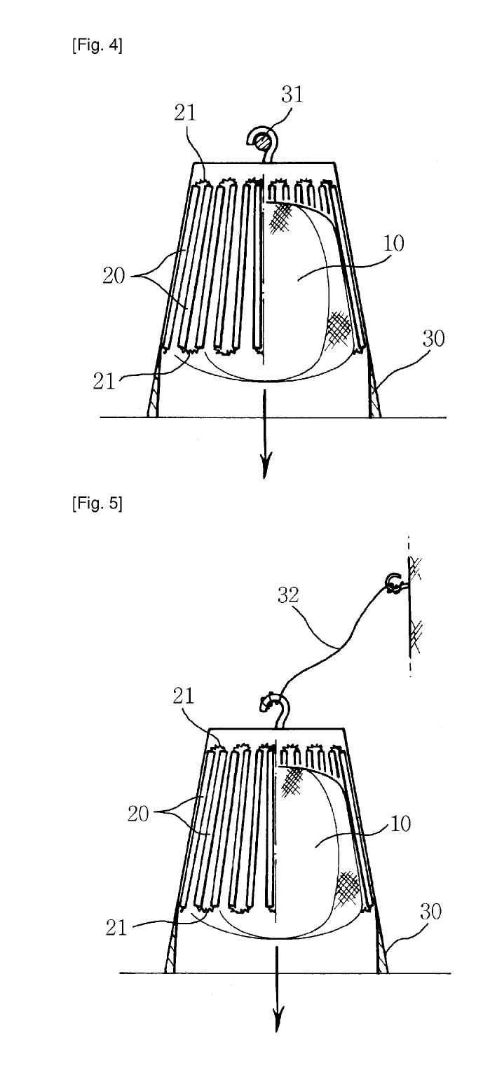

FIG. 1 is a front view showing a lifesaving parachute in use, FIG. 2 is a plane view showing a spread state of the lifesaving parachute according to a preferred embodiment of the present invention, FIG. 3 is a plane view showing a routine for folding the lifesaving parachute of the present invention, FIG. 4 is a partially taken cross-sectional view showing the lifesaving parachute in storage. FIG. 5 is a partially taken cross-sectional view showing the lifesaving parachute, which is received in a receiving case held outside a building to be used in the case of fire.

A main body 10 of the lifesaving parachute is in the same structure with a general one used for military purpose and the like, wherein the main body 10 is formed of a fiber sheet strong enough to stand air resistance not to be torn and provided with straps 11 at a lower part for the wearing of a user.

The straps 11 are provided with hooks or buckles for the user to hold the same to a waist belt or shoulder straps.

The main body 10 is mounted with stick elements 20 connected to each other by elastic elements 21 along a periphery of the main body 10.

The elastic elements 21 are formed of rubber materials or coil springs having very strong elasticity to straightly spread out when no external force is applied thereto.

The elastic elements 21 stably fix the stick elements 20 for preventing deviation of the stick elements 20, wherein the stick elements 20 may be formed of synthetic resin or metal materials in the rod-shape.

The stick elements 20 should be attached to the periphery of the main body 10 of the parachute stably. Therefore, the main body 10 formed of the fabric materials are preferably sewed after surrounding the stick elements 20 to attach the stick elements 20 to the main body 10.

The main body 10 is well folded and received in a receiving case 30 for keeping.

The receiving case 30 is opened at a bottom part for receiving the main body 10 as folded and injection-molded in the shape of empty receiving case.

The receiving case 30 is integrally formed with a ring 31 or connected to a strap 32 at an opposite side of the opening part for the main body 10 of the parachute to spread out in a short time in an emergency such as fire.

The ring 31 is held by a pipe such as a rail of an apartment building and helps the main body 10 to be immediately separated from the receiving case 30 when the user jumps after the user couples the hooks or buckles, which are formed at ends of the straps 11 (not shown), with his waist belt or shoulder straps.

The receiving case 30 is mounted to an outer wall of a building by holding the straps 32 to the rail of the outer wall of the building as described above, and the main body 10 is immediately separated from the receiving case 30 when the user jumps after fixing the hooks or buckles, which are formed at the ends of the straps 32 (not shown), to his waist belt or shoulder straps.

As described above, the main body 10 is deviated from the receiving case 30 and, at this moment, the elastic force is applied from the elastic elements 21 to the stick elements 20 for spreading the stick elements 20 straightly, if the user jumps while the receiving case 30 is held outside the building and the straps 11 are connected to a body of the user.

Therefore, the stick elements 20 spread by the elasticity of the elastic elements 21 when the main body 10 is deviated from the receiving case 30, and the parachute spreads at a very short instant, for example, in 0.5 seconds.

FIG. 3 shows a routine that the parachute of the present invention is folded. In FIG. 3, the main body 10 is folded at each position of the elastic elements 21 in the zig zag shape, and the straps 11 are positioned at the lower part of the main body 10 in the state that the main body 10 is folded in a smallest volume, so that the main body 10 is received in the receiving case 30 to be able to be withdrawn.

The parachute of the present invention is also usable for the military purpose, wherein the parachute should spread out from a low place at a low height.

According to the present parachute in the above structure, it is not necessary to mount any auxiliary parachute at a peak part of a main parachute.

Further, according to the parachute of the present invention, any highly skilled technique is not necessary any more to guarantee definite spread of the parachute without any malfunction, so that the parachute of the present invention is simple in manufacture and repetitive in use.

The parachute of the present invention realizes safe falling of the user even in the case of rain since the parachute may be forcedly spread instantly by the elasticity of the elastic elements 21.

The parachute of the present invention may be recovered to its normal shape by the elasticity even the parachute collides with any obstacles during falling thereof, thereby guaranteeing the safety.

### INDUSTRIAL APPLICABILITY

As described hereinabove, according to the present invention, the main body 10 of the parachute spreads in a very short time by the elastic elements 21 and the stick elements 20 as the user jumps from a building after the user wears the parachute by holding ends of the straps 11 to his waist belt or shoulder straps in the case of fire of a high-storied building, while the main body 10 of the parachute is kept in the receiving case 30 as being held outside the building in normal times.

Therefore, the user may land on the ground slowly and safely by the air resistance applied to the main body 10 of the parachute, which is in the spread situation. Therefore, the parachute of the present invention helps the saving of human lives and protecting people from injury.

The main body 10 of the parachute is installed at the high-storied building as being received in the receiving case 30 for saving human lives safely in the case of fire.

Although the foregoing description has been made with reference to the preferred embodiments, it is to be understood that changes and modifications of the present invention may be made by the ordinary skilled in the art without departing from the spirit and scope of the present invention and appended claims.

1. A lifesaving parachute, comprising:
a main body having straps for a user to wear the parachute;
stick elements formed of a unit length and fixed to the main body along a periphery thereof;
elastic elements connected to connection elements of the stick elements for applying elastic force to the stick elements in a spreading direction of the stick elements; and
an empty receiving case having an opened lower part for receiving the main body as folded.

2. A lifesaving parachute as claimed in claim 1, wherein the elastic elements are coil springs.

3. A lifesaving parachute as claimed in claim 1, wherein the receiving case is formed with a ring.
